(19) United States
(12) Patent Application Publication
(10) Pub. No.: US 2003/0212981 A1
(43) Pub. Date: Nov. 13, 2003

(54) Method utilizing dummy patterns to fabricate active region for stabilizing lithographic process

(76) Inventors: Chong-Jen Huang, Sanchung City (TW); Hsin-Huei Chen, Miaoli (TW); Kuong-Wen Liu, Nantou (TW); Chih-Hao Wang, Taoyuan City (TW); Jia-Rong Chiou, Keelung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/141,122

(22) Filed: May 9, 2002

(51) Int. Cl. G06F 17/50

(52) U.S. Cl. 716/19

(57) ABSTRACT

The present invention provides a method utilizing dummy patterns to fabricate active region for stabilizing lithographic process. An original pattern layer of active region is first provided, and an attached diffusion layer of dummy patterns is then matched. Logic operations are used to combine the original pattern layer of active region and the attached diffusion layer of dummy patterns together to fill the attached diffusion layer of dummy patterns in more spacious region of the original pattern layer of active region for increasing the pattern density of active region for mask fabrication, hence acquiring a photo mask meeting the requirement of logic device product and applying to logic devices having different pattern densities of active region. Difference of density between products can thus be reduced. The present invention utilizes dummy patterns to simplify and stabilize lithographic process. Simultaneously, lens heating effect can also be reduced.

### FIELD OF THE INVENTION

The present invention relates to a method for stabilizing lithographic process and, more particularly, to a method utilizing dummy patterns to fabricate active region so as to simplify and stabilize lithographic process for variable product.

### BACKGROUND OF THE INVENTION

When the density of integrated circuit (IC) continually increases, in order to keep or even shrink the area of chip to reduce the unit cost of circuit, the only way is to continually shrink the design rule of circuit. Therefore, lithographic lithography needs to become more and more miniature gradually. Otherwise, the technology development of ICs will halt immediately.

Most present semiconductor fabrication techniques use the conventional optical method for exposure. However, limit of exposure linewidth is restricted due to wave characteristic of optics. Therefore, in order to achieve a thinner linewidth, it is necessary to use a light source of shorter wavelength. The wavelength of light source used in the present semiconductor industry is shortened to 248 nm. Even this wavelength has already achieved the limit of interference in the more advanced process. Therefore, a very complicated phase shifting mask method needs to be used in the more advanced sub-micrometer process.

As can be known from above, lithographic lithography relates to exposure linewidth. The thinner the linewidth, the shorter wavelength in lithography is required to avoid the diffraction phenomenon and obtain an accurate pattern. If light of the same wavelength is used to expose devices of different linewidths, some regions can be accurately exposed, but the diffraction phenomenon will occur in some regions. Moreover, because a general production line of logic devices has its particularity, pattern densities of active region usually differ because of difference of products. Even in the process of the same product, lithographic process of each procedure also differs. In other words, the condition of lithographic process of each procedure needs to be changed. Therefore, in order to resolve this kind of problem, lithographic process is tuned to meet the requirement of product in most of conventional processes, resulting in trouble in mass production and complicating the production line.

Accordingly, the present invention aims to propose a method utilizing dummy patterns to fabricate active region for stabilizing lithographic process so as to resolve the above problems.

### SUMMARY AND OBJECTS OF THE PRESENT Invention

The primary object of the present invention is to propose a method utilizing special and regular dummy patterns for active region mask to fill spacious regions so as to increase pattern density of the active region mask, thereby stabilizing lithographic process.

Another object of the present invention is to reduce difference of density of active region mask between products to simplify lithographic process and obtain a stable process.

Yet another object of the present invention is to provide a method utilizing dummy patterns to fabricate active region mask for stabilizing lithographic process and reducing lens heating effect to minimum during lithographic process.

To achieve the above objects, the present invention utilizes logic operations to combine an original pattern layer of active region and an attached diffusion layer of special and regular dummy patterns together to let the attached diffusion layer of dummy patterns fill more spacious regions of the original pattern layer of active region and let the patterns and densities thereof be combined together to form a final pattern diffusion layer for final mask fabrication, hence acquiring a mask of logic device conforming to the conditions of pattern density and pattern distribution.

The various objects and advantages of the present invention will be more readily understood from the following detailed description when read in conjunction with the appended drawings, in which:

### BRIEF DESCRIPTION OF DRAWINGS

FIG. 1 is a cross-sectional view of an embodiment of the present invention; and

FIGS. 2A to 2H show attached diffusion layers of dummy patterns according to various kinds of embodiments of the present invention.

### DETAILED DESCRIPTION OF PREFERRED EMBODIMENT

The present invention discloses a method utilizing dummy patterns to fabricate active region for stabilizing lithographic process. The primary procedure of the present invention utilizes special and regular dummy patterns of active region to fill more spacious region of the active region mask, thereby increasing pattern density of the active region mask. After filling in dummy patterns, density of the active region between products will be more uniform, hence greatly reducing difference of density of the active region between products.

During the lithography process, pattern densities of the active region usually differ from product to produce because of the characteristic of general logic devices. The conditions of lithographic process thus need to be changed in each procedure, hence complicating the process, affecting the stability of process, and usually resulting in trouble in mass production. Therefore, the present invention combines an original pattern layer of active region and an attached diffusion layer of dummy patterns together to obtain a final pattern layer meeting the requirement of logic device products, hence applying to logic devices with different pattern densities of active region without the need of changing the conditions of lithographic process for the different product of same process technology. The above original pattern layer and attached diffusion layer are made of the same material on the mask.

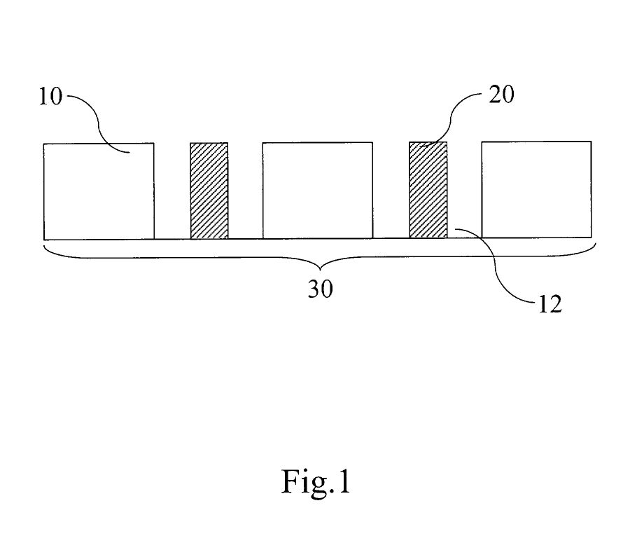

Speaking in detail, as shown in FIG. 1, the present invention first provides an original pattern layer 10 of active region required by a device. The original pattern layer 10 has a more spacious active region 12. An attached diffusion layer 20 of special and regular dummy patterns is then provided. The pattern distribution of the attached diffusion layer 20 of dummy patterns is different from that of the original pattern layer 10 of active region. Finally, logic operations are used to combine the original pattern layer 10 of active region and the attached diffusion layer 20 of dummy patterns together so that the patterns and densities thereof can be combined together to form a final pattern diffusion layer 30 for mask fabrication, hence obtaining a mask of logic device conforming to the conditions of pattern density and pattern distribution.

For example, if the pattern density of active region of a first logic manufacture product is 52% (dark/total), it is necessary to fabricate a original pattern layer 10 having a pattern density of 52% so that the fabricated mask can be used in the lithography process to obtain an active region having a pattern density of 52% in a semiconductor substrate. If the original pattern density of active region of a second logic manufacture product is 26%, the process condition for the first product with 52% mask pattern density cannot be used. Therefore, it is necessary to add an attached diffusion layer 20 of dummy patterns and use logic operations to combine the original pattern layer 10 of active region and the attached diffusion layer 20 of dummy patterns together so that the attached diffusion layer 20 of dummy patterns can be filled in spacious region of the original pattern layer 10 of active region to form a final pattern diffusion layer 30 for mask fabrication whose pattern density increases from the original 26% to the required 50%, hence obtaining a final mask for the second logic product having a pattern density of 50%. The trouble of tuning lithographic process can thus be avoided by using a final mask obtained by combining an original pattern layer 10 of active region and an attached diffusion layer 20 of dummy patterns together to fabricate logic product with different density original pattern, thereby simplifying lithographic process and acquiring a stable process.

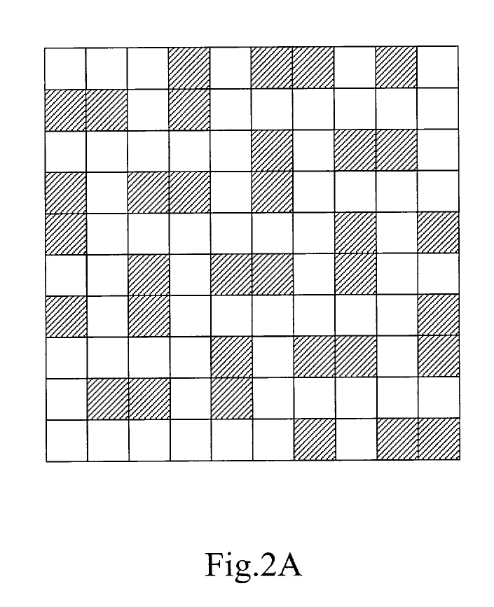

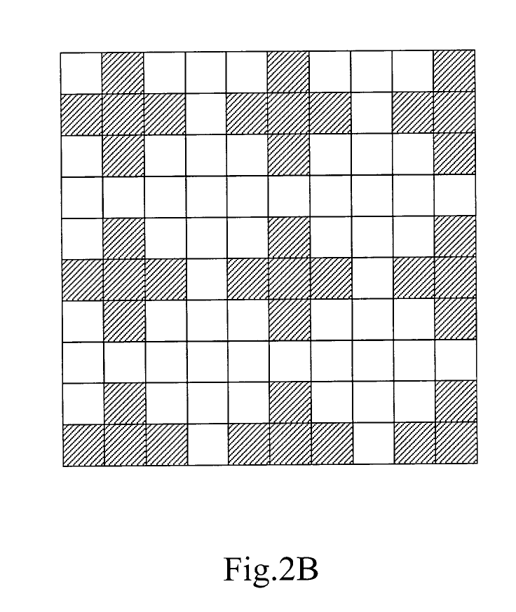

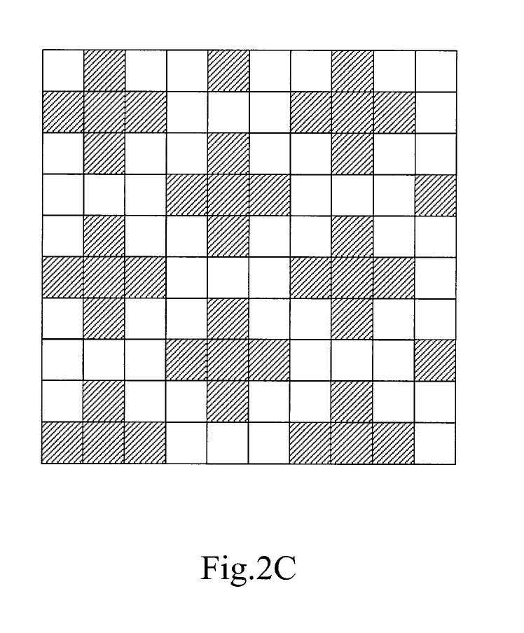

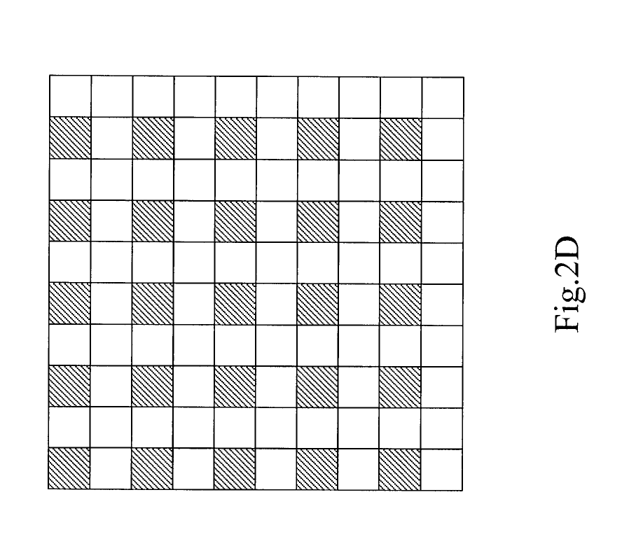

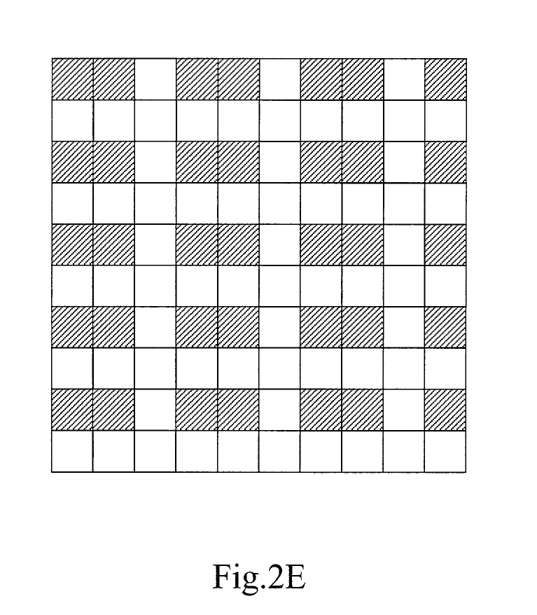

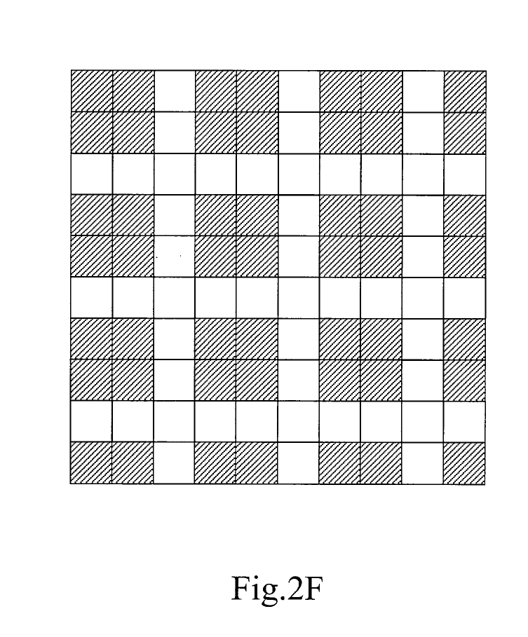

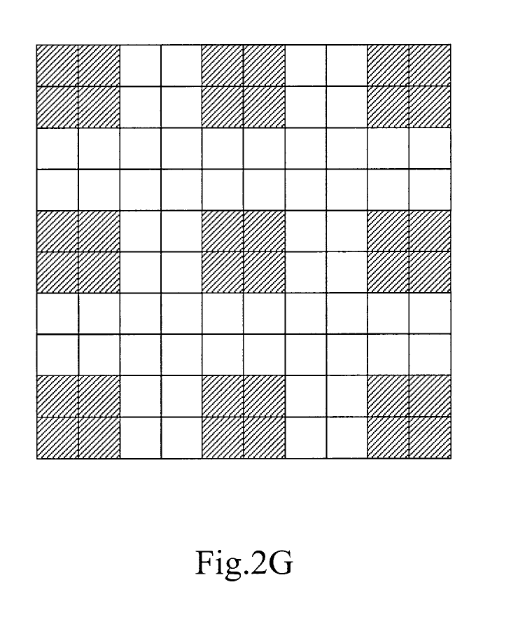

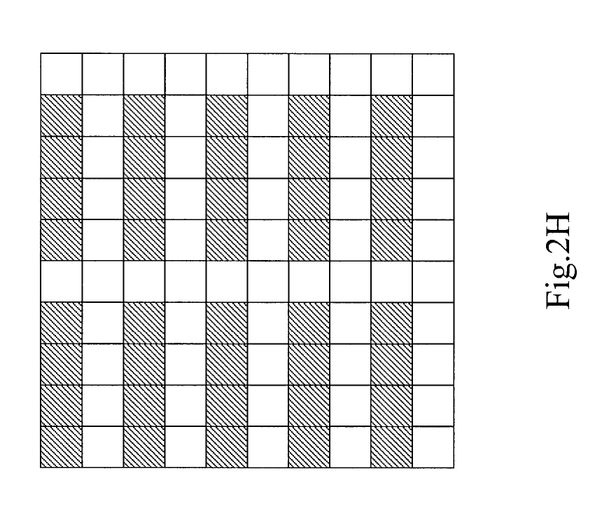

Besides, the pattern density of mask is similar to avoid the lens heating parameter control issue. The above attached diffusion layer 20 of dummy patterns is formed by arranging rectangles with side ratio of 1:1 alternately or in array, by arranging crosses formed by stacking rectangles with side ratio of 2:1 alternately or in array, or by arranging crosses formed by stacking rectangles with side ratio of 3:1 alternately or in array. The pattern density of this kind of attached diffusion layer of dummy patterns having various kinds of arranged patterns is within 25% to 45% (dark/total). Please refer to FIGS. 2A to 2H, the pattern density of FIG. 2A is 33.3%, the pattern density of FIG. 2B is 31.25%. the pattern density of FIG. 2C is 41.66%, the pattern density of FIG. 2D is 25%, the pattern density of FIG. 2E is 33.5%, the pattern density of FIG. 2F is 44.4%, the pattern density of FIG. 2G is 25%, and the pattern density of FIG. 2H is 40%. Different attached diffusion layers of dummy patterns can be selected according to different requirements of logic products.

Before forming the required pattern layer of active region in a semiconductor substrate, the present invention first utilizes an attached diffusion layer of dummy patterns to fill more spacious region of a original pattern layer of active region to increase pattern density of product and form a final diffusion layer, hence fabricating a pattern layer of logic device product. Therefore, the above method of utilizing dummy patterns to let density of active region be uniform can reduce difference of pattern density of logic products, simplify lithographic process, and stabilize the process. Moreover, lens heating effect during the lithographic process can be reduced to minimum. Most importantly, the trouble in mass production of logic products can be resolved.

Although the present invention has been described with reference to the preferred embodiments thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. A method utilizing dummy patterns to fabricate active region for stabilizing lithographic process, comprising the steps of:
providing an original pattern layer of active region required by a device;
forming an attached diffusion layer of special and regular dummy patterns; and
using logic operations to combine said original pattern layer of active region and said attached diffusion layer of dummy patterns together to form a final diffusion layer for mask fabrication, hence acquiring a mask of logic product.

2. The method as claimed in claim 1, wherein said attached diffusion layer of dummy patterns is combined with said original pattern layer of active region to let pattern density be uniform and conform to the required pattern of logic product.

3. The method as claimed in claim 1, wherein the pattern of said attached diffusion layer of dummy patterns is formed by alternately arranging rectangles with side ratio of 1:1.

4. The method as claimed in claim 1, wherein the pattern of said attached diffusion layer of dummy patterns is formed by arranging crosses formed by stacking rectangles with side ratio of 2:1 in array.

5. The method as claimed in claim 1, wherein the pattern of said attached diffusion layer of dummy patterns is formed by alternately arranging crosses formed by stacking rectangles with side ratio of 3:1.

6. The method as claimed in claim 1, wherein the pattern of said attached diffusion layer of dummy patterns is formed by arranging rectangles with side ratio of 1:1 in array.

7. The method as claimed in claim 1, wherein the pattern of said attached diffusion layer of dummy patterns is formed by arranging rectangles with side ratio of 2:1 in array.

8. The method as claimed in claim 1, wherein the pattern density of said attached diffusion layer of dummy patterns is within 25% to 45%.

9. The method as claimed in claim 1, wherein said original pattern layer of active region and said attached diffusion layer of dummy patterns are made of the same material on mask.
